(19) United States
(12) Patent Application Publication
(10) Pub. No.: US 2025/0051546 A1
(43) Pub. Date: Feb. 13, 2025

(54) PROCESS FOR PREPARING POLYBUTENE COMPOSITIONS HAVING INCREASED CRYSTALLIZATION TEMPERATURE

(71) Applicant: Basell Poliolefine Italia S.r.l., Milano (IT)

(72) Inventors: Michele Grazzi, Ferrara (IT); Roberta Marchini, Ferrara (IT)

(73) Assignee: Basell Poliolefine Italia S.r.l., Milano (IT)

(21) Appl. No.: 18/719,153

(22) PCT Filed: Dec. 12, 2022
(86) PCT No.: PCT/EP2022/085317

§ 371 Date: Jun. 12, 2024

(30) Foreign Application Priority Data
Dec. 21, 2021 (EP) 21216215.0

(51) Int. Cl. C08K 5/25; C08J 3/20; C08K 3/34

(52) U.S. Cl. CPC C08K 5/25; C08J 3/201; C08K 3/346; C08J 2323/22; C08K 2201/003

(57) ABSTRACT

A process for producing a polybutene-1 composition including the step of:

blending
A) from 99.5 to 99.9% by weight, with respect to the total weight of A)+B), of a butene-1 polymer which is brought to a molten state or maintained in a molten state during the blending step; and
B) from 0.1 to 0.5% by weight, with respect to the total weight of A)+B), of an alkanoyl hydrazine;
   wherein the resulting polybutene-1 composition, having a crystallization temperature T_{c}^{C} satisfying the following relation:

$${T}_{c}^{C} \geq {T}_{c}^{A} + 5$$

where T_{c}^{A} is the crystallization temperature of the butene-1 polymer A).

### FIELD OF THE INVENTION

In general, the present disclosure relates to the field of chemistry. More specifically, the present disclosure relates to polymer chemistry. In particular, the present disclosure relates to a process for producing polybutene-1 compositions and the resulting polybutene-1 compositions.

### BACKGROUND OF THE INVENTION

In some instances, the crystallization temperature of polyolefins is increased by adding nucleating agents. In some instances, these nucleating agents are foreign materials, which promote the crystallization of the polymer from the melt (heterogeneous nucleation). In some instances and as a consequence of the nucleation effect, optical and mechanical are enhanced.

### SUMMARY OF THE INVENTION

In a general embodiment, the present disclosure provides a process for producing a polybutene-1 composition, having an increased crystallization temperature Tc, including the step of:

blending
A) from 99.5 to 99.9% by weight, with respect to the total weight of A)+B), of a butene-1 polymer selected from the group consisting of butene-1 homopolymers, butene-1 copolymers, and mixtures thereof, wherein the butene-1 polymer being brought to a molten state or maintained in a molten state during the blending step;
B) from 0.1 to 0.5% by weight, with respect to the total weight of A)+B), of an alkanoyl hydrazine of formula (I):

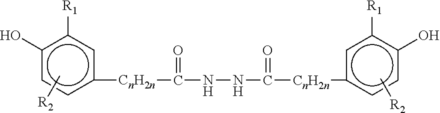

wherein R₁ is an alkyl group containing from 1 to 6 carbon atoms, R₂ is hydrogen or an alkyl group containing from 1 to 6 carbon atoms, and n is an integer number from 0 to 5;
wherein the resulting polybutene-1 composition, having a crystallization temperature T_{c}^{C} satisfying the following relation:

$${T}_{c}^{C} \geq {T}_{c}^{A} + 5$$

where T_{c}^{A} and T_{c}^{C} are expressed in ° C., T_{c}^{A} is the crystallization temperature of the butene-1 polymer A), and crystallization temperatures T_{c}^{A} and T_{c}^{C} being determined by differential scanning calorimetry (DSC), with a heating and cooling rate of 10° C./minute.

In some embodiments, the present disclosure provides a process for producing a polybutene-1 composition, having an increased crystallization temperature Tc, including the step of:
blending
A) from 99.5 to 99.9% by weight, alternatively from 99.6 to 99.85% by weight, with respect to the total weight of A)+B), of a butene-1 polymer selected from the group consisting of butene-1 homopolymers, butene-1 copolymers, and mixtures thereof, wherein the butene-1 polymer being brought to a molten state or maintained in a molten state during the blending step;
B) from 0.1 to 0.5% by weight, alternatively from 0.15 to 0.4% by weight, with respect to the total weight of A)+B), of an alkanoyl hydrazine of formula (I),
   wherein the resulting polybutene-1 composition, having a crystallization temperature T_{c}^{C} satisfying the following relation:

$${T}_{c}^{C} \geq {T}_{c}^{A} + 5$$

where T_{c}^{A} and T_{c}^{C} are expressed in ° C., T_{c}^{A} is the crystallization temperature of the butene-1 polymer A), and crystallization temperatures T_{c}^{A} and T_{c}^{C} being determined by differential scanning calorimetry (DSC), with a heating and cooling rate of 10° C./minute. In some embodiments, T_{c}^{A} is equal to or higher than 60° C., alternatively equal to or higher than 65° C.

In some embodiments, the present disclosure provides a polybutene-1 composition made from or containing:
A) from 99.5 to 99.9% by weight, alternatively from 99.6 to 99.85% by weight, with respect to the total weight of A)+B), of a butene-1 polymer selected from the group consisting of butene-1 homopolymers, butene-1 copolymers, and mixtures thereof, wherein the butene-1 polymer having crystallization temperature T_{c}^{A} equal to or higher than 60° C., alternatively equal to or higher than 65° C.;
B) from 0.1 to 0.5% by weight, alternatively from 0.15 to 0.4% by weight, with respect to the total weight of A)+B), of an alkanoyl hydrazine of formula (I);
   wherein the resulting polybutene-1 composition having a crystallization temperature T_{c}^{C} satisfying the following relation:

$${T}_{c}^{C} \geq {T}_{c}^{A} + 5.$$

### DETAILED DESCRIPTION OF THE INVENTION

In some embodiments, the polybutene-1 compositions have a crystallization temperature T_{c}^{C} satisfying the following relation:

$${T}_{c}^{C} \geq {T}_{c}^{A} + 10.$$

In some embodiments, the polybutene-1 compositions have a crystallization temperature T_{c}^{C} satisfying the following relation:

$${T}_{c}^{C} \geq {T}_{c}^{A} + 15.$$

As used herein, the crystallization temperatures are determined after a single melting cycle, with a scanning speed of 10° C./minute.

Consequently, due to the fact that the crystallization temperatures are measured in a cooling run carried out after first melting the polymer sample, the crystallization temperatures are attributable to the crystalline form II of the butene-1 polymer.

In some embodiments, more than a single crystallization peak is detected. In those embodiments, the temperature of the more or the most intense peak is taken as the Tc value for both the butene-1 polymer component A) and the polybutene-1 composition.

In some embodiments, the polybutene-1 composition has a crystallization half-time at 95° C. of from 50 to 150 seconds, alternatively from 65 to 130 seconds.

In some embodiments, the crystallization half-time is determined by DSC, by first melting the sample, then rapidly cooling the sample to a certain temperature and measuring the heat flow caused by the crystallization exotherm. In some embodiments, the certain temperature is 95° C. The integral of heat transfer is recorded as a function of time until the crystallization is complete, that is, heat transfer ceases.

As used herein, the term “crystallization half-time” refers to the time at which the heat transfer integral reaches half of heat transfer integral's final value.

In some embodiments, the polybutene-1 composition has at least one of the following additional features:
a T_{c}^{C} value equal to or higher than 85° C., alternatively from 85° C. to 98° C.;
a tensile elastic modulus from 500 to 800 MPa, alternatively from 550 to 750 MPa, measured at 23° C. via DMTA analysis according to ISO 6721-4:2019 on 1 mm thick compression molded plaque;
a value of Charpy impact resistance at 23° C. from 3 to 20 kJ/m², alternatively from 5 to 15 kJ/m², measured according to ISO 179-1:2010 1eA;
a value of Charpy impact resistance at 0° C. from 1 to 10 KJ/m², alternatively from 1 to 5 kJ/m², measured according to ISO 179-1:2010 1eA; or
a value of Charpy impact resistance at −23° C. from 1 to 8 KJ/m², alternatively from 1 to 3 kJ/m², measured according to ISO 179-1:2010 1eA.

In some embodiments, butene-1 polymer component A) is made or containing one or more butene-1 copolymers. In some embodiments, the butene-1 copolymers are made from or containing one or more comonomer(s) selected from the group consisting of ethylene, propylene, and CH₂═CHR alpha-olefins, where R is a C₃-C₈ alkyl radical. In some embodiments, the CH₂═CHR alpha-olefins are selected from the group consisting of pentene-1,4-methyl-pentene-1, hexene-1, and octene-1.

In some embodiments, the comonomers are selected from the group consisting of ethylene, propylene, and hexene-1.

As used herein, the term “copolymers” includes polymers containing more than a single kind of comonomer.

In some embodiments, the butene-1 polymer component A) is commercially available.

In some embodiments, the butene-1 polymer component A) is a linear polymer, which is highly isotactic.

In some embodiments, the butene-1 polymer component A) has an isotacticity from 90 to 99%, alternatively from 93 to 99%, alternatively from 95 to 99%, measured as mmmm pentads/total pentads with ¹³C-NMR operating at 150.91 MHz, or as quantity by weight of matter insoluble in xylene at 0° C.

In some embodiments, the butene-1 polymer component A) has a MI₂ value of from 0.05 to 50 g/10 min., alternatively from 0.1 to 10 g/10 min., wherein MI₂ is the Melt Flow Index MI at 190° C. with a load of 2.16 kg, measured according to ISO 1133-1:2011.

In some embodiments, the MI₁₀ value of the butene-1 polymer component A) is 1 to 100 g/10 min., alternatively 2 to 50 g/10 min., wherein MI₁₀ is the Melt Flow Index MI at 190° C. with a load of 10 kg, measured according to ISO 1133-1:2011.

In some embodiments, the butene-1 polymer component A) has a ratio MI₁₀/MI₂ of from 20 to 40, alternatively from 25 to 35.

In some embodiments, the butene-1 polymer component A) is selected from the group consisting of homopolymers.

In some embodiments, the butene-1 polymer A) is selected from the group consisting of copolymers having a comonomer content of from 0.5% to 10% by mole, alternatively of from 0.7% to 9% by mole. In some embodiments, the comonomer is ethylene.

In some embodiments, the butene-1 polymer component A) is a butene-1 polymer composition made from or containing:

A1) a butene-1 homopolymer or a copolymer of butene-1 with at least one comonomer selected from the group consisting of ethylene, propylene, the previously defined CH₂═CHR olefins, and mixtures thereof, having a copolymerized comonomer content of up to 2% by mole; and
A2) a copolymer of butene-1 with at least one comonomer selected from the group consisting of ethylene, propylene, the previously defined CH₂═CHR olefins, and mixtures thereof, having a copolymerized comonomer content of from 3 to 25% by mole; and
having a total copolymerized comonomer content of 0.5-18% by mole, alternatively of from 0.7 to 15% by mole, referred to the sum of A1)+A2).

In some embodiments, the relative amounts of A1) and A2) range from 10% to 40% by weight, alternatively from 15% to 35% by weight, of A1) and from 90% to 60% by weight, alternatively from 85% to 65% by weight, of A2), wherein the amounts being referred to the sum of A1)+A2).

In some embodiments, the butene-1 polymer component A) has at least one of the following additional features:
an upper limit of the crystallization temperature of 80° C.;
a flexural modulus value from 100 to 800 MPa, alternatively from 250 to 600 MPa, alternatively from 300 to 600 MPa, measured according to norm ISO 178:2010, 10 days after molding;
a molecular weight distribution Mw/Mn equal to higher than 4, alternatively equal to or higher than 5, wherein Mw is the weight average molar mass and Mn is the number average molar mass, measured by Gel Permeation Chromatography;
a melting point TmII, measured by DSC (Differential Scanning calorimetry) in the second heating run with a scanning speed of 10° C./min., equal to or lower than 125° C., alternatively equal to or lower than 120° C.;
a content of fraction soluble in xylene at 0° C. of 15% by weight or lower, alternatively of 10% by weight or lower, referred to the total weight of A); or
an X-ray crystallinity of from 25 to 65%. In some embodiments, the molecular weight distribution Mw/Mn has an upper limit of 10. In some embodiments, the melting point TmII has a lower limit of 75° C. In some embodiments, the content of fraction soluble in xylene at 0° C. has a lower limit being of 0.5% by weight.

In some embodiments, the butene-1 polymer component A) has at least one of the following further additional features:
an intrinsic viscosity (I.V.) measured in tetrahydronaphthalene (THN) at 135° C., equal to or lower than 5 dl/g, alternatively equal to or lower than 3 dl/g;
an Mw equal to or greater than 100000 g/mol, alternatively from 100000 to 650000 g/mol;
a melting point TmI, measured by DSC with a scanning speed of 10° C./min., from 95° C. to 135° C.;
a density of 885-925 kg/m³, alternatively of 900-920 kg/m³, alternatively of 912-920 kg/m³. In some embodiments, the intrinsic viscosity (I.V.) has a lower limit of 0.4 dl/g.

In some embodiments, the butene-1 polymer component A) is obtained by low-pressure Ziegler-Natta polymerization of butene-1. In some embodiments, the butene-1 polymer component A) is obtained by polymerizing butene-1 (and any comonomers) with catalysts based on TiCl₃, or halogenated compounds of titanium supported on magnesium chloride, and a co-catalyst. In some embodiments, the halogenated compound of titanium is TiCl₄. In some embodiments, the co-catalyst is an alkyl compound of aluminum. In some embodiments, electron-donor compounds are added to the catalyst components to tailor the polymer properties, like molecular weights and isotacticity. In some embodiments, the electron-donor compounds are selected from the group consisting of esters of carboxylic acids and alkyl alkoxysilanes.

In some embodiments, the butene-1 polymer component A) is prepared by polymerization of the monomers in the presence of a stereospecific catalyst made from or containing (i) a solid component made from or containing a Ti compound and an internal electron-donor compound supported on MgCl₂; (ii) an alkylaluminum compound; and optionally, (iii) an external electron-donor compound.

In some embodiments, magnesium dichloride in active form is used as a support. In some embodiments, Ziegler-Natta catalysts supported on magnesium dichloride in active form are used in Ziegler-Natta catalysts as described in U.S. Pat. Nos. 4,298,718 and 4,495,338. In some embodiments, the magnesium dihalides in active form used as support or co-support in components of catalysts for the polymerization of olefins, are characterized by X-ray spectra wherein the most intense diffraction line that appears in the spectrum of the non-active halide is diminished in intensity and replaced by a halo having a maximum intensity displaced towards lower angles relative to that of the more intense line.

In some embodiments, the titanium compounds used in the catalyst component (i) are selected from the group consisting of TiCl₄, TiCl₃, and Ti-haloalcoholates of formula Ti(OR)_{n-y} X_{y}, where n is the valence of titanium, X is halogen, and y is a number between 1 and n. In some embodiments, the halogen is chlorine.

In some embodiments, the internal electron-donor compound is selected from the group consisting of esters. In some embodiments, the esters are selected from the group consisting of alkyl, cycloalkyl, or aryl esters of monocarboxylic acids, or polycarboxylic acids, wherein the alkyl, cycloalkyl, or aryl groups having from 1 to 18 carbon atoms. In some embodiments, the monocarboxylic acids are benzoic acids. In some embodiments, the polycarboxylic acids are selected from the group consisting of phthalic acids, succinic acids, and glutaric acids. In some embodiments, the electron-donor compounds are selected from the group consisting of diisobutyl phthalate, diethylphthalate, dihexylphthalate, diethyl glutarate, diisobutyl glutarate, and 3,3-dimethyl glutarate. In some embodiments, the internal electron-donor compound is used in molar ratio with respect to the MgCl₂ of from 0.01 to 1, alternatively from 0.05 to 0.5.

In some embodiments, the alkyl-Al compound (ii) is selected from the group consisting of trialkyl aluminum compounds. In some embodiments, the trialkyl aluminum compounds are selected from the group consisting of triethylaluminum, triisobutylaluminum, tri-n-butylaluminum, tri-n-hexylaluminum, and tri-n-octylaluminum. In some embodiments, the alkyl-Al compound (ii) is a mixture of trialkylaluminum compounds with alkylaluminum halides, alkylaluminum hydrides, or alkylaluminum sesquichlorides. In some embodiments, the alkylaluminum sesquichlorides are selected from the group consisting of AlEt₂Cl and Al₂Et₃Cl₃.

In some embodiments, the external electron-donor compounds (iii) are silicon compounds of formula Rₐ¹R_{b}²Si(OR³)_{c}, wherein a and b are integer from 0 to 2, c is an integer from 1 to 3, and the sum (a+b+c) is 4; and R¹, R², and R³ are alkyl, cycloalkyl, or aryl radicals with 1-18 carbon atoms optionally containing heteroatoms. In some embodiments, a is 0, c is 3, b is 1, R² is a branched alkyl or cycloalkyl group, optionally containing heteroatoms, and R³ is methyl. In some embodiments, the silicon compounds are selected from the group consisting of cyclohexyltrimethoxysilane, t-butyltrimethoxysilane, diisopropyltrimethoxysilane, and thexyltrimethoxysilane. In some embodiments, the silicon compound is thexyltrimethoxysilane.

In some embodiments, the external electron-donor compound (iii) is used in an amount such that the molar ratio between the alkyl-Al compound (ii) and the external electron-donor compound (iii) is from 0.1 to 500, alternatively from 1 to 300, alternatively from 3 to 100.

In some embodiments, the catalyst is pre-polymerized in a pre-polymerization step. In some embodiments, the prepolymerization is carried out in liquid (slurry or solution) or in the gas-phase. In some embodiments, the prepolymerization is carried out at temperatures lower than 100° C., alternatively between 2° and 70° C. The prepolymerization step is carried out with quantities of monomers, thereby obtaining the polymer in amounts of between 0.5 and 2000 g per g of solid catalyst component, alternatively between 5 and 500 g, alternatively between 10 and 100 g.

In some embodiments, the butene-1 polymer component A) is obtained by polymerizing the monomer(s) in the presence of a metallocene catalyst system obtainable by contacting:
a stereorigid metallocene compound;
an alumoxane or a compound capable of forming an alkyl metallocene cation; and, optionally,
an organo aluminum compound.

In some embodiments, the polymerization process is carried out with the catalysts by operating in liquid phase, optionally in the presence of an inert hydrocarbon solvent, or in gas phase, using fluidized bed or mechanically agitated gas phase reactors.

In some embodiments, the hydrocarbon solvent is aromatic or aliphatic. In some embodiments, the aromatic solvent is toluene. In some embodiments, the aliphatic solvent is selected from the group consisting of propane, hexane, heptane, isobutane, cyclohexane, 2,2,4-trimethylpentane, and isododecane.

In some embodiments, the polymerization process is carried out by using liquid butene-1 as polymerization medium.

In some embodiments, the polymerization temperature is from 20° C. to 150° C., alternatively from 50° C. to 90° C., alternatively from 65° C. to 82° C.

In some embodiments and to control the molecular weights, a molecular weight regulator is fed to the polymerization environment. In some embodiments, the molecular weight regulator is hydrogen.

As used herein, Mw/Mn values equal to or higher than 4 and the previously defined values of the MI₁₀/MI₂ ratio refer to a broad molecular weight distribution (MWD).

In some embodiments, butene-1 polymers, having a broad MWD, are obtained by (co) polymerizing butene-1 in the presence of a catalyst. In some embodiments, butene-1 polymers, having a broad MWD, are obtained by mechanically blending butene-1 polymers having different molecular weights.

In some embodiments, a multistep polymerization process is used, wherein the butene-1 polymers with different molecular weights are prepared in sequence in two or more reactors with different reaction conditions, such as the concentration of molecular weight regulator fed in each reactor.

In some embodiments, different monomer amounts are fed into each reactor.

In some embodiments, the butene-1 polymer component A) is made from or containing two components A1) and A2) and the polymerization process is carried out in two or more reactors connected in series, wherein components B1) and B2) are prepared in separate subsequent stages, operating in each stage, except for the first stage, in the presence of the polymer formed and the catalyst used in the preceding stage.

In some embodiments, the catalyst is added in the first reactor and not subsequent reactors. In some embodiments, the catalyst is added in more than one reactor.

In some embodiments, high MI values are obtained directly in polymerization. In some embodiments, high MI values are obtained by subsequent chemical treatment (chemical visbreaking).

In some embodiments, the chemical visbreaking of the polymer is carried out in the presence of free radical initiators, such as the peroxides.

In some embodiments, the peroxides have a decomposition temperature ranging from 150° C. to 250° C. In some embodiments, the peroxides are selected from the group consisting of di-tert-butyl peroxide, dicumyl peroxide, 2,5-dimethyl-2,5-di(tert-butylperoxy) hexyne, and 2,5-dimethyl-2,5-di(tert-butylperoxy) hexane. In some embodiments, the peroxides are commercially available.

In some embodiments, the quantity of peroxide for the visbreaking process ranges from 0.001 to 0.5% by weight of the polymer, alternatively from 0.001 to 0.2%.

In some embodiments, the alkyl groups R₁ and R₂ in the alkanoyl hydrazine B) of formula (I) is selected from the group consisting of methyl, ethyl, propyl, isopropyl, butyl, t-butyl, pentyl, and hexyl. In some embodiments, the alkyl groups R₁ and R₂ are t-butyl.

In some embodiments, the alkanoyl hydrazine B) has the following formula (II):

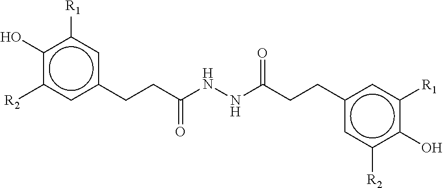

wherein R₁ and R₂ have the same meaning as previously reported in formula (I).

In some embodiments, the alkanoyl hydrazine B) is the compound N,N′-bis-β-(3,5-di-tert-butyl-4-hydroxyphenyl)-propionyl-hydrazine, also called 2′,3-Bis[[3-[3,5-di-tert-butyl-4-hydroxyphenyl]propionyl]]propionohydrazide, having formula (III):

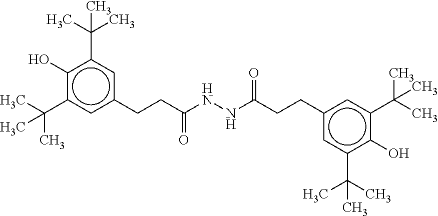

In some embodiments, alkanoyl hydrazine B) is prepared by a reaction between hydrazine and an ester of an alkylhydroxyphenylalkanoic acid, followed by further acylation, as described in U.S. Pat. No. 3,773,722.

In some embodiments, the alkanoyl hydrazine of formula (III) is commercially available under the trade name Irganox 1024, from BASF.

In some embodiments, the polybutene-1 composition is further made from or containing talc as optional component C).

In some embodiments, amounts of component C) are from 0.15% to 2.5% by weight, alternatively from 0.2% to 2% by weight, alternatively from 0.2% to 1.5% by weight, referred to the total weight of A)+B)+C).

In some embodiments, talc is in the form of particles, having a volume-based (volumetric), particle-diameter distribution Dv (0.95) of 45 μm or lower, alternatively of 35 μm or lower, alternatively of 25 μm or lower, alternatively of 20 μm or lower, determined by laser light diffraction. In some embodiments, the lower limit is 5 μm.

In some embodiments, component C) has at least one of the following, further volume-based, particle-diameter distribution features:
Dv (0.99) of 100 μm or lower, alternatively of 50 μm of lower, alternatively of 30 μm or lower;
Dv (0.90) of 20 μm or lower, alternatively of 15 μm of lower;
Dv (0.50) of 10 μm or lower, alternatively of 8 μm or lower; or
Dv (0.10) of 5 μm or lower, alternatively of 4 μm or lower. In some embodiments, the lower limit of Dv (0.99) is 10 μm. In some embodiments, the lower limit of Dv (0.90) is 3 μm. In some embodiments, the lower limit of Dv (0.50) is 2 μm. In some embodiments, the lower limit of Dv (0.10) is 1 μm.

As used herein and for volume-based, particle-diameter, the diameter of an equivalent sphere having the same volume as the subject particle is meant.

Accordingly, the values of volume-based, particle-diameter distribution indicates that the specified volume fraction of particles, for instance 95% by volume for Dv (0.95), has an equivalent diameter of less than the given value.

Such determination is carried out by laser diffraction.

In some embodiments, the analytical equipment used is a Malvern Mastersizer instrument.

Talc is a hydrated magnesium silicate.

In some embodiments, talc has the formula Mg₃Si₄O₁₀(OH)₂.

In some embodiments, talc is a hydrated magnesium silicate, optionally associated with other mineral materials, such as chlorite (hydrated magnesium aluminum silicate) and dolomite.

In some embodiments and to achieve the values of particle diameter distribution, talc is milled. In some embodiments, talc is milled with air classified mills, compressed air, steam, and impact grinding.

In some embodiments, the polybutene-1 composition is obtained by blending components A), B) and optionally C).

In some embodiments, the polybutene-1 composition is obtained by extruders. In some embodiments, the blending equipment is selected from the group consisting of single-screw extruders, CoKneader (like the Buss), twin corotating screw extruders, and mixers (continuous and batch). In some embodiments, the blending apparatuses are equipped with separate feeding systems for components A), B) and optionally C) respectively. In some embodiments, component B) and the optional component C) are added to the polymer mass inside the blending apparatus. In some embodiments, the blending apparatus is an extruder. In some embodiments, component B) and the optional component C) are added in the same feed port or downstream from the point at which A) is fed into the blending apparatus. In some embodiments, the distance between (i) component A and (ii) component B) and the optional component C) permits A) to reach the form of a melted, homogeneous mass.

In some embodiments, components B) and C) are fed in the form of masterbatch in a polymer carrier, alternatively in a polyolefin carrier, alternatively a polybutene carrier of the same kind as the butene-1 polymer component A).

In some embodiments, the processing temperatures, during the blending step, melt component A) or keep component A) in a molten state when B) and optionally C) are added. In some embodiments, the temperatures range from 100° C. to 220° C., alternatively from 150 to 220° C., alternatively from 180 to 220° C.

In some embodiments, polybutene-1 composition is further made from or containing additives. In some embodiments, the additives are selected from the group consisting of stabilizing agents (against heat, light, or U.V.), plasticizers, antiacids, antistatic agents, water repellant agents, and pigments.

In some embodiments, polybutene-1 composition is used for making pipes and pipe joints. In some embodiments, the present disclosure provides an article of manufacture made from or containing the polybutene-1 composition. In some embodiments, the article of manufacture is a pipe or a pipe joint. In some embodiments, the pipes are for carrying water or hot fluids.

### EXAMPLES

The following examples are illustrative and not intended to limit the scope of the appended claims.

The following analytical methods are used to characterize the polymer compositions and filaments.

### Crystallization and Melting Temperature

The crystallization temperature (T_{c}) and the melting temperature values were determined using the following procedure.

Differential scanning calorimetric (DSC) data were obtained using a Perkin Elmer DSC-7 instrument. A weighed sample (5-10 mg) was sealed into aluminum pans and heated at 200° C. with a scanning speed corresponding to 10° C./minute. The sample was kept at 200° C. for 5 minutes, thereby melting the crystallites and cancelling the thermal history of the sample. Successively, by cooling to −20° C. with a scanning speed corresponding to 10° C./minute, the peak temperature was taken as crystallization temperature (T_{c}) and the area as the crystallization enthalpy. After standing 5 minutes at −20° C., the sample was heated for the second time to 200° C. with a scanning speed corresponding to 10° C./min. In this second heating run, the peak temperature was taken as the melting temperature of the polybutene-1 crystalline form II (TmII) and the area as the melting enthalpy (ΔHfII).

To determine the melting temperature of the polybutene-1 crystalline form I (TmI), the sample was melted, kept at 200° C. for 5 minutes, and then cooled down to 20° C. with a cooling rate of 10° C./min. The sample was then stored for 10 days at room temperature. After 10 days, the sample was subjected to DSC, cooled to −20° C., and then heated to 200° C. with a scanning speed corresponding to 10° C./min. In this heating run, the first peak temperature coming from the lower temperature side in the thermogram was taken as the melting temperature (Tml).

### Crystallization Half-Time at 95° C.

Differential scanning calorimetric (DSC) data were obtained using a Perkin Elmer DSC-7 instrument. A weighed sample (5-10 mg) was sealed into aluminum pans and heated from room temperature to 180° C. with a scanning speed corresponding to 10° C./minute.

The sample was kept at 180° C. for 5 minutes, thereby melting the crystallites and cancelling the thermal history of the sample.

Successively, the sample was cooled to 95° C. with a scanning speed corresponding to 60° C./minute. The heat flow caused by the crystallization exotherm at 95° C. was measured. The integral of heat transfer was recorded as a function of time until the crystallization was complete, that is, heat transfer ceased.

The crystallization half-time was the time at which the heat transfer integral reached half of heat transfer integral's final value.

### Particle Size Distribution

Particle size distribution (PSD) was measured by laser diffraction according to ISO 13320:2009.

The equipment used was a Mastersizer® 2000 with sample dispersion unit, from Malvern UK.

The detection system had the following features:
Red light: forward scattering, side scattering, back scattering;
Blue light: wide angle forward and back scattering;
Light sources: Red light He—Ne Laser; Blue light solid state light source;
Optical alignment system: Automatic rapid align system with dark field optical reticule;
Laser system: Class 1 laser product.

PSD determination was based on the optical diffraction principle of the laser monochromatic light scattered through a dispersed particulate sample. The signal was received by a computer interfaced to the instrument, for processing the received signals and turning the signals into a dimensional physical quantities.

The results were expressed by a PSD report consisting of 106 classes of diameter (virtual sieves) with related cumulative percentages in terms of volume and additional derived parameters.

It is worth noting that the measurement data can be contaminated by background electrical noise and also by scattering data from dust on the optics and contaminants floating in the dispersant. As such, the sample dispersion unit was cleaned, and traces of impurities and residual material were removed.

A background measurement with pure dispersant (solvent) as well as a measurement of the electrical background was made. The total background value obtained was subtracted from the sample measurement, thereby obtaining corrected sample data.

For the background measurement, 250 cc. of anhydrous n-heptane solvent containing 2 g/l SPAN 80 Pure as antistatic agent were introduced into the sample dispersion unit. Air residual in solvent was removed by ultrasonic treatment (60 seconds) prior to sample measurements.

The solvent was then sent to the measurement cell, while stirrer and recycle pump were operating at an output range of 2205 rpm.

### Measurement

The sample, kept in suspension in anhydrous n-heptane by stirring, was added directly into the sample unit.

A 2-minute sample suspension recycling promoted disaggregation of aggregates (if present).

The monitor showed the obscuration bar, allowing optimal volume concentration of sample. The concentration of sample corresponded to obscuration values ranging from 10% to 30%, providing a representative and stable result.

The refractive index (RI) was set to:
Particle RI: 1.596;
Dispersant RI: 1.390.

The measurement time was of 4 seconds.

The signals received from the laser equipment were processed. The PSD was then calculated by the software provided with the Mastersizer apparatus.

### Melt Flow Index MI

Determined according to ISO 1133-1:2011 at 190° C. with the specified load.

### Intrinsic Viscosity

Determined according to norm ASTM D 2857-16 in tetrahydronaphthalene at 135° C.

### Tensile Elastic Modulus (MET-DMTA)

Determined at 23° C. via Dynamic Mechanical Thermal Analysis (DMTA) according to ISO 6721-4:2019 on 1 mm thick compression-molded plaque, measured 10 days after molding.

### Flexural Modulus

Measured according to norm ISO 178:2019, measured 10 days after molding.

### Charpy Impact Resistance at 23° C., 0° C. and −23° C.

Measured according to ISO 179-1:2010 1eA, 10 days after molding.

### Comonomer Contents

The comonomer content of the butene-1 polymers was determined via FT-IR.

The spectrum of a pressed film of the polymer was recorded in absorbance vs. wavenumbers (cm⁻¹). The following measurements were used to calculate the ethylene content:
a) area (Aₜ) of the combination absorption bands between 4482 and 3950 cm⁻¹ which was used for spectrometric normalization of film thickness.
b) factor of subtraction (FCR_{C2}) of the digital subtraction between the spectrum of the polymer sample and the absorption band due to the sequences BEE and BEB (B: 1,butene units, E: ethylene units) of the methylenic groups (CH₂ rocking vibration).
c) Area (A_{C2,block}) of the residual band after subtraction of the C₂PB spectrum, which comes from the sequences EEE of the methylenic groups (CH₂ rocking vibration).

### Apparatus

A Fourier Transform Infrared spectrometer (FTIR) was used.

A hydraulic press with platens heatable to 200° C. (Carver or equivalent) was used.

### Method

### Calibration of (BEB+BEE) Sequences

A calibration straight line was obtained by plotting % (BEB+BEE)wt vs. FCR_{C2}/Aₜ. The slope Gᵣ and the intercept Iᵣ were calculated from a linear regression.

### Calibration of EEE Sequences

A calibration straight line was obtained by plotting % (EEE)wt vs. A_{C2,block}/Aₜ. The slope G_{H} and the intercept I_{H} were calculated from a linear regression.

### Sample Preparation

Using a hydraulic press, a thick sheet was obtained by pressing about 1.5 grams of sample between two aluminum foils. If homogeneity was uncertain, a minimum of two pressing operations occurred. A small portion was cut from this sheet to mold a film. The film thickness was between 0.1-0.3 mm.

The pressing temperature was 140±10° C.

Because a crystalline phase modification takes place with time, the IR spectrum of the sample film was collected as soon as the sample was molded.

### Procedure

The instrument data acquisition parameters were as follows:
Purge time: 30 seconds minimum.
Collect time: 3 minutes minimum.
Apodization: Happ-Genzel.
Resolution: 2 cm⁻¹.
Collect the IR spectrum of the sample vs. an air background.

### Calculation

Calculate the concentration by weight of the BEE+BEB sequences of ethylene units:

$$\% ( BEE + BEB ) wt = {G}_{r} \cdot \frac{{FCR}_{C 2}}{{A}_{t}} + {I}_{r}$$

Calculate the residual area (AC2,block) after the subtraction described above, using a baseline between the shoulders of the residual band.
Calculate the concentration by weight of the EEE sequences of ethylene units:

$$\% ( EEE ) wt = {G}_{H} \cdot \frac{{A}_{C 2 , block}}{{A}_{t}} + {I}_{H}$$

Calculate the total amount of ethylene percent by weight:

$$\% C 2 wt = [ \% ( BEE + BEB ) wt + \% ( EEE ) wt ]$$

### Determination of Isotactic Pentads Content

The ¹³C NMR spectra were acquired on a polymer solution (8-12 wt %) in dideuterated 1,1,2,2-tetrachloro-ethane at 120° C. The ¹³C NMR spectra were acquired on a Bruker AV-600 spectrometer, operating at 150.91 MHz in the Fourier transform mode at 120° C. equipped with cryo-probe, using a 90° pulse, 15 seconds of delay between pulses and CPD (WALTZ16), thereby removing ¹H-¹³C coupling. About 512 transients were stored in 32K data points using a spectral window of 60 ppm (0-60 ppm). The mmmm pentad peak (27.73 ppm) was used as the standard.
The assignments were made as described in the literature (Macromolecules 1991, 24, 2334-2340, by Asakura T.).
The percentage value of pentad tacticity (mmmm %) for butene-1 polymers is the percentage of stereoregular pentads (isotactic pentad) as calculated from the relevant pentad signals (peak areas) in the NMR region of branched methylene carbons as:

mmmm %=100A1/(A1+A2)

where A1 was the area between 28.0 and 27.59 ppm;
A2 was the area between 27.59 and 26.52 ppm.

### Fractions Soluble and Insoluble in Xylene at 0° C. (XS−0° C.)

2.5 g of the polymer sample were dissolved in 250 ml of xylene at 135° C. under agitation. After 30 minutes, the solution was allowed to cool to 100° C., under agitation, and then placed in a water and ice bath to cool down to 0° C. Then, the solution was allowed to settle for 1 hour in the water and ice bath. The precipitate was filtered with filter paper. During the filtering, the flask was left in the water and ice bath, thereby keeping the flask inner temperature near 0° C. After filtering, the filtrate temperature was balanced at 25° C., dipping the volumetric flask in a water-flowing bath for about 30 minutes, and then divided in two 50 ml aliquots. The solution aliquots were evaporated in nitrogen flow, and the residue dried under vacuum at 80° C. until a constant weight was reached. If the weight difference between the two residues was less than 3%, the test was terminated. If the weight difference between the two residues was not less than 3%, the test was repeated. The percent by weight of polymer soluble (Xylene Solubles at 0° C.=XS 0° C.) was calculated from the average weight of the residues. The insoluble fraction in o-xylene at 0° C. (xylene Insolubles at 0° C.=XI % 0° C.) is:

$$XI \% 0 ° C . = 100 - XS \%0 ° C .$$

### Determination of X-Ray Crystallinity

The X-ray crystallinity was measured with an X-ray Diffraction Powder Diffractometer using the Cu-Kα1 radiation with fixed slits and collecting spectra between diffraction angle 2Θ=5° and 2Θ=35° with step of 0.1° per 6 seconds.

Measurements were performed on compression-molded specimens in the form of disks of about 1.5-2.5 mm of thickness and 2.5-4.0 cm of diameter. These specimens were obtained in a compression molding press at a temperature of 200° C.±5° C. without any appreciable applied pressure for 10 minutes, then applying a pressure of about 10 kg/cm² for about a few seconds and repeating this last operation 3 times.

The diffraction pattern was used to derive the components for the degree of crystallinity by defining a linear baseline for the whole spectrum and calculating the total area (Ta), expressed in counts/sec·2Θ, between the spectrum profile and the baseline. Then an amorphous profile was defined, along the whole spectrum, that separates, according to the two phase model, the amorphous regions from the crystalline regions. The amorphous area (Aa), expressed in counts/sec·2Θ, was calculated as the area between the amorphous profile and the baseline; and the crystalline area (Ca), expressed in counts/sec·2Θ, was calculated as Ca=Ta−Aa.

The degree of crystallinity of the sample was then calculated according to the formula:

$$\% Cr = 100 \times Ca / Ta$$

### Mw/Mn Determination by GPC

The determination of the means Mn and Mw, and Mw/Mn derived therefrom was carried out using a Waters GPCV 2000 apparatus, which was equipped with a column set of four PLgel Olexis mixed-gel (Polymer Laboratories) and an IR4 infrared detector (PolymerChar). The dimensions of the columns were 300×7.5 mm with particle size 13 μm. The mobile phase used was 1-2-4-trichlorobenzene (TCB) with a flow rate at 1.0 ml/min. The measurements were carried out at 150° C. Solution concentrations were 0.1 g/dl in TCB and 0.1 g/l of 2,6-di-tert-butyl-p-cresole were added, thereby preventing degradation. For GPC calculation, a universal calibration curve was obtained using 10 polystyrene (PS) standard samples supplied by Polymer Laboratories (peak molecular weights ranging from 580 to 8500000). A third order polynomial fit was used to interpolate the experimental data and obtain the calibration curve. Data acquisition and processing were done using Empower (Waters). The Mark-Houwink relationship was used to determine the molecular weight distribution and the relevant average molecular weights: the K values were K_{PS}=1.21×10⁻⁴ dL/g and K_{PB}=1.78×10⁻⁴ dL/g for PS and PB respectively, while the Mark-Houwink exponents α=0.706 for PS and α=0.725 for PB were used.

For butene-1/ethylene copolymers, the composition was assumed constant in the whole range of molecular weight and the K value of the Mark-Houwink relationship was calculated using a linear combination:

$${K}_{EB} = {x}_{E} {K}_{PE} + {x}_{P} {K}_{PB}$$

where K_{EB} was the constant of the copolymer, K_{PE}(4.06×10⁻⁴, dL/g) and K_{PB}(1.78×10⁻⁴ dl/g) were the constants of polyethylene and polybutene and x_{E} and x_{B} were the ethylene and the butene-1 weight % content. The Mark-Houwink exponents α=0.725 was used for the butene-1/ethylene copolymers.

### Density

Determined according to norm ISO 1183-1:2019 at 23° C., 10 days after molding.

### Examples 1 and 2 and Comparison Examples 1 and 2

The following materials are used to prepare the polybutene-1 composition.

### Butene-1 Polymer A)

Butene-1 homopolymer prepared with a Ziegler-Natta catalyst in liquid monomer polymerization, having a flexural modulus of 450 MPa, MI₁₀ of 12 g/10 min., MI₂ of 0.4 g/10 min., a content of fraction soluble in xylene at 0° C. of 2% by weight, and a density of 914 kg/cm³.

The butene-1 homopolymer was commercially available under trademark Toppyl PB 0110M, from LyondellBasell.

### Alkanoyl Hydrazine Component B)

Alkanoyl hydrazine having formula (III) as reported above, was commercially available from BASF under trademark Irganox 1024.

### Talc C)

Talc having the volume based particle diameter distribution reported in Table 1, was commercially available from Imi Fabi under trademark HM05.

### Irgafos 168®

Tris (2,4-di-tert-butylphenyl) phosphite was a thermal stabilizer, commercially available from Ciba Geigy.

TABLE I

| Talc C) | | HM05 |
|---|---|---|
| Dv (0.10) | μm | 3.27 |
| Dv (0.50) | μm | 6.25 |
| Dv (0.90) | μm | 11.70 |
| Dv (0.95) | μm | 13.70 |
| Dv (0.99) | μm | 17.79 |

### Preparation of the Polybutene-1 Composition

The components were melt-blended in a Leistritz Micro 27 extruder with co-rotating twin screw, 27 mm screw diameter segmented, 40:1 L/D ratio, 500 rpm max screw speed.

The main extrusion parameters were:
Temperature: 200° C.;
Screw speed: 200 rpm;
Output: 15 kg/h.

The amounts of the components and the properties of the resulting final compositions are reported in Table 2.

TABLE 2

| Example No. | 1 | 2 | Comp. 1 | Comp. 2 |
|---|---|---|---|---|
| A) [% by weight] | 99.7 | 99.1 | 99.9 | 99.3 |
| B) [% by weight] | 0.2 | 0.2 | — | — |
| C) [% by weight] | — | 0.6 | — | 0.6 |
| Irgafos 168 [% by weight] | 0.1 | 0.1 | 0.1 | 0.1 |
| MI₂ [g/10 min.] | 0.4 | 0.4 | 0.4 | 0.4 |
| Mw/Mn | 9.5 | 9 | 9.2 | 8.9 |
| Tc [° C.] | 90.66 | 94.34 | 71.24 | 83.2 |
| TmI [° C.] | 131.1 | 130.8 | 127 | 129.4 |
| TmII [° C.] | 117.4 | 118 | 115.7 | 129.4 |
| Crystallization half-time at | 78 | n.m. | 750 | 192 |
| 95° C. [seconds] | | | | |
| Tensile elastic modulus at 23° | 580 | 667 | 546 | 606 |
| C. via DMTA [MPa] | | | | |
| Charpy at 23° C. [kJ/m²] | 10 | 5.6 | 23.8 | 15 |
| Charpy at 0° C. [kJ/m²] | 2.9 | 2 | 7.8 | 4.5 |
| Charpy at −23° C. [kJ/m²] | 2 | 1.4 | 3.9 | 2.4 |

Note:
n.m. = not measured.

What is claimed is:

1. A process for producing a polybutene-1 composition, comprising the step of:
blending
A) from 99.5 to 99.9% by weight, with respect to the total weight of A)+B), of a butene-1 polymer selected from the group consisting of butene-1 homopolymers, butene-1 copolymers, and mixtures thereof, wherein the butene-1 polymer being brought to a molten state or maintained in a molten state during the blending step; and
B) from 0.1 to 0.5% by weight, with respect to the total weight of A)+B), of an alkanoyl hydrazine of formula (I): 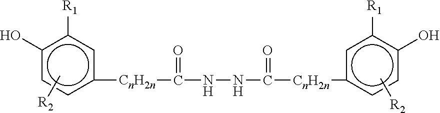
wherein R₁ is an alkyl group containing from 1 to 6 carbon atoms, R₂ is hydrogen or an alkyl group containing from 1 to 6 carbon atoms, and n is an integer number from 0 to 5;
wherein the resulting polybutene-1 composition, having a crystallization temperature T_{c}^{C} satisfying the following relation:
$${T}_{c}^{C} \geq {T}_{c}^{A} + 5 ;$$
where TA and T_{c}^{C} are expressed in ° C., T_{c}^{A} is the crystallization temperature of the butene-1 polymer A), and crystallization temperatures being determined by differential scanning calorimetry (DSC), with a heating and cooling rate of 10° C./minute.

2. The process of claim 1, wherein talc C) is added in the blending step.

3. The process of claim 2, wherein the talc C) is in the form of particles, having a volume based particle diameter distribution Dv (0.95) of 45 μm or lower, determined by laser light diffraction.

4. The process of claim 1, wherein the blending step is carried out at a temperature from 100° C. to 220° C.

5. The process of claim 1, wherein the alkanoyl hydrazine B) has formula (II): 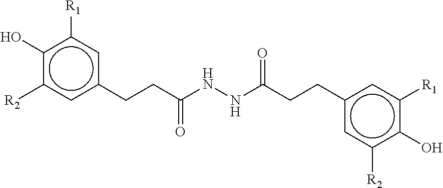
wherein R₁ is an alkyl group containing from 1 to 6 carbon atoms and R₂ is hydrogen or an alkyl group containing from 1 to 6 carbon atoms.

6. The process of claim 5, wherein B) has formula (III):

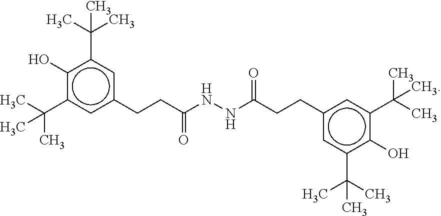

7. A polybutene-1 composition comprising:
A) from 99.5 to 99.9% by weight, with respect to the total weight of A)+B), of a butene-1 polymer selected from the group consisting of butene-1 homopolymers, butene-1 copolymers, and mixtures thereof, wherein the butene-1 polymer having crystallization temperature T_{c}^{A} equal to or higher than 60° C.; and
B) from 0.1 to 0.5% by weight, with respect to the total weight of A)+B), of an alkanoyl hydrazine of formula (I): 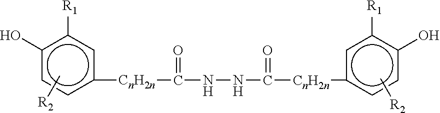
wherein R₁ is an alkyl group containing from 1 to 6 carbon atoms, R₂ is hydrogen or an alkyl group containing from 1 to 6 carbon atoms, and n is an integer number from 0 to 5;
wherein the polybutene-1 composition having a crystallization temperature T_{c}^{C} satisfying the following relation:
$${T}_{c}^{C} \geq {T}_{c}^{A} + 5 ;$$
where T_{c}^{A} and T_{c}^{C} are expressed in ° C., T_{c}^{A} is the crystallization temperature of the butene-1 polymer A) and crystallization temperatures T_{c}^{A} and T_{c}^{C} being determined by differential scanning calorimetry (DSC), with a heating and cooling rate of 10° C./minute.

8. The polybutene-1 composition of claim 7, further comprising talc C).

9. The polybutene-1 composition of claim 8, wherein the talc C) is in the form of particles having a volume based particle diameter distribution Dv (0.95) of 45 μm or lower, determined by laser light diffraction.

10. The polybutene-1 composition of claim 8, wherein the talc C) is present in an amount from 0.15% to 2.5% by weight, referred to the total weight of A)+B)+C).

11. The polybutene-1 composition of claim 7, wherein the alkanoyl hydrazine B) has formula (II): 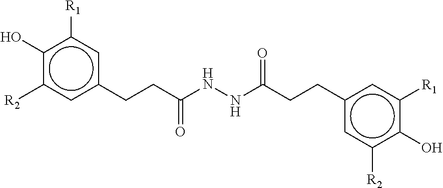
wherein R₁ is an alkyl group containing from 1 to 6 carbon atoms and R₂ is hydrogen or an alkyl group containing from 1 to 6 carbon atoms.

12. The polybutene-1 composition of claim 11, wherein B) has formula (III):

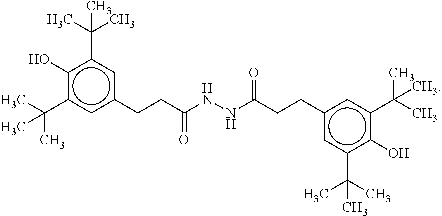

13. The polybutene-1 composition of claim 7, having a T_{c}^{C} value equal to or higher than 85° C.

14. An article of manufacture comprising the polybutene-1 composition of claim 7.
